(19) United States
(12) Patent Application Publication
(10) Pub. No.: US 2005/0009991 A1
(43) Pub. Date: Jan. 13, 2005

(54) Impact resistant compositions

(76) Inventors: Prasadarao Meka, Seabrook, TX (US); Jeffrey Valentage, Royal Oak, MI (US); Paul Joseph Burke, Royal Oak, MI (US)

Correspondence Address: ExxonMobil Chemical Company;Law Technology, P O Box 2149, Baytown, TX, 77522-2149, US

(21) Appl. No.: 10/493,953

(22) PCT Filed: Nov. 5, 2002
(86) PCT No.: PCT/US02/35389

Related U.S. Application Data
(60) Provisional application No. 60/332,922, filed on Nov. 19, 2001.

(51) Int. Cl. C08L 23/00; C08L 23/04

(52) U.S. Cl. 525/240

(57) ABSTRACT

Embodiments of the present invention include a composition formed from (a) 50 wt % to 85 wt % of at least one impact copolymer relative to the total weight of the composition, the impact copolymer comprising up to 25 wt % of an ethylene-propylene rubber, the rubber having a content of ethylene-derived units of from 40 wt % to 60 wt % relative to the rubber; and (b) 50 wt % to 15 wt % of at least one plastomer relative to the total weight of the composition, wherein the plastomer is a copolymer of ethylene derived units and at least one of C₃ to C₈ α-olefin derived units from 5 wt % to 30 wt % of the plastomer. The composition is useful for automotive components, especially interior automotive components such as airbag covers, the composition having a secant flexural modulus of at least 50 kpsi (345 MPa) and 100% ductility down to −40° C.

### FIELD OF INVENTION

The present invention relates to compositions including plastomers and impact copolymers, and more particularly to compositions useful in automotive components, especially airbag covers and the like.

### BACKGROUND OF THE INVENTION

Airbags have become a standard safety feature in most automobiles. Inclusive in the technology surrounding these devices are the covers used to protect the airbags while in its resting state behind the various fascia within the passenger compartment of the automobile. Given that the airbag must deploy from its resting state within, for example, interior portions of the steering wheel or dashboard, etc., the design and physical properties of the airbag cover can be critical.

Compositions for early airbag covers have been disclosed in, for example, U.S. Pat. Nos. 5,747,592, 6,060,551, 5,110,647, and JP (unexamined publications) 10265628, 1097912, and 11181174. These disclosures address the problems inherent in early designs of airbags and airbag covers. However, as airbags have evolved, it has become important to improve both the ease of manufacture and aesthetics of the airbag covers, while maintaining or improving the performance of these covers.

For example, an older method of making the airbag covers involved the blending of oils into a styrenic-containing and/or talc-containing polymer material to make the plastic soft enough for use as the cover. The problem with this is that the cover then becomes too soft to be used extensively as a unitary fascia component (e.g., a dashboard, pillar trim, etc.), and typically ends up being a separate component from the other interior automotive components, thus increasing the cost of automotive manufacturing, as at least two parts having distinct properties must be produced and assembled as part of an interior or exterior component.

What would be desirable is an airbag cover that can be made continuous with the facade of the other interior components of the automobile such as the steering wheel, pillar trim, dash board, etc. This would require a composition that can be used to make components that have a higher stiffness (e.g., as measured by the flexural modulus) and improved impact resistance (e.g., as measured by the impact at −18 to −40° C.). The present invention solves these and other problems.

### SUMMARY OF THE INVENTION

An embodiment of the present invention includes a composition formed from (a) 50 wt % to 85 wt % of at least one impact copolymer relative to the total weight of the composition, the impact copolymer comprising up to 25 wt % of an ethylene-propylene rubber, the rubber having a content of ethylene-derived units of from 40 wt % to 60 wt % relative to the rubber; and (b) 50 wt % to 15 wt % of at least one plastomer relative to the total weight of the composition, wherein the plastomer is a copolymer of ethylene derived units and at least one of C₃ to C₈ α-olefin derived units from 5 wt % to 30 wt % of the plastomer.

Another embodiment of the present invention includes a composition formed from (a) from 50 wt % to 85 wt % of at least one impact copolymer relative to the total weight of the composition, the impact copolymer formed from a Component A and Component B; (i) wherein from 50% to 95% by weight Component A based on the total weight of the impact copolymer, Component A comprising propylene homopolymer or copolymer, wherein the copolymer comprises 10% or less by weight ethylene, butene, hexene or octene derived units and the amount of amorphous polypropylene in Component A is less than 2 wt %; and (ii) from up to 50% by weight Component B based on the total weight of the impact copolymer, Component B comprising polypropylene copolymer, wherein the copolymer comprises from 20% to 70% by weight of ethylene, butene, hexene and/or octene derived units, and from 80% to 30% by weight propylene derived units; and (b) from 50 wt % to 15 wt % of at least one plastomer relative to the total weight of the composition, wherein the plastomer is a copolymer of ethylene derived units and at least one of C₃ to C₈ α-olefin derived units from 5 wt % to 30 wt % of the plastomer.

In yet another embodiment, the present invention includes a unitary interior automotive component comprising a composition of an impact copolymer and a plastomer, wherein the plastomer is a copolymer of ethylene derived units and at least one of C₃ to C₈ α-olefin derived units from 5 wt % to 35 wt % of the plastomer.

The plastomer is preferably metallocene produced. The impact copolymer is produced in a Ziegler-Natta catalyzed process in one embodiment, and in a metallocene catalyzed process in another embodiment. The compositions are useful for automotive components such as unitary airbag covers having a secant flexural modulus of greater than 50 kpsi (345 MPa) in one embodiment, and greater than 90 kpsi (620 MPa) in another embodiment.

### BRIEF DESCRIPTION OF DRAWINGS

FIG. 1 is a schematic representation of the instrumented impact testing, defining the approximate points along the load versus time curve wherein failure occurs as indicated by the precipitous drop in the load a function of time;

FIG. 2 is a plot of load as a function of time for data representing an instrumented impact test (5 runs) of Sample 5;

FIG. 3 is a plot of load as a function of time for data representing an instrumented impact test (5 runs) of Sample 6; and

FIG. 4 is a plot of load as a function of time for data representing an instrumented impact test (5 runs) of Sample 11.

### DETAILED DESCRIPTION OF THE INVENTION

The present invention includes compositions having improved stiffness and impact strength for use in automotive parts, particularly interior unitary components such as airbag covers. The compositions include blends of polypropylene-based impact copolymers and plastomers. The compositions do not require the addition of cross-linkers or processing oils in order to be used in desirable applications, and can be thermoformed or injection molded into the desired articles of manufacture. Below is a more detailed description of embodiments of the components forming the compositions of the invention.

As used herein, the term “composition” includes a blend of at least one impact copolymer and at least one plastomer. The composition may also include other components and additives common in interior or exterior automotive components.

As described herein, polymers and copolymers of olefinic monomers are referred to as polymers or copolymers including or comprising olefinic “derived units. ” Thus, for example, a copolymer formed by the polymerization of hexene and ethylene may be referred to as a copolymer of ethylene derived units and hexene derived units.

Impact Copolymers

As used herein, the term “impact copolymer” (“ICP”) shall mean those blends of polypropylene and rubber which are substantially thermoplastic and have a flexural modulus in the range of 40,000-250,000 psi (276-1724 MPa). The ICPs have a “polypropylene component” and a “rubber component”. Most typically, useful ICPs have a polypropylene content in the range of 50 wt % to 95 wt % in one embodiment, and from 50 wt % to 85 wt % in another embodiment; and a rubber content in the range of up to 50 wt % in one embodiment, and a rubber content of up to 25 wt % in another embodiment. The rubber may include up to 70 wt % ethylene derived units or other C₄ to C₁₀ α-olefin derived units by weight of the rubber, or from 20 to 70 wt % ethylene derived units or other C₄ to C₁₀ α-olefin derived units by weight of the rubber in another embodiment, or from 40 to 60 wt % ethylene derived units or other C₄ to C₁₀ α-olefin derived units in yet another embodiment.

The polypropylene may be homopolypropylene, propylene based copolymers, or combinations of the two. The term “polypropylene”, as used in this description and the appended claims, is defined to mean any propylene based polymer having a propylene content of at least 80 wt %. In most applications it will be desirable that the polypropylene phase be continuous or nearly continuous.

The rubber phase exists in discrete domains dispersed throughout the polypropylene phase. Most commonly, the rubber will be an ethylene-propylene rubber or an ethylene-propylene terpolymer rubber, however, other rubber compositions may be used. The term “rubber”, as used in this description and the appended claims shall mean any essentially non-crystalline polymeric component having a low glass transition temperature (typically ≦−35° C.), typically a copolymer of propylene derived units and at least one other monomer derived unit selected from ethylene and at least one C₄ to C α-olefin. The base ICP may also include additional fillers, pigments, stabilizers and property modifiers.

The manner in which the ICPs are produced is not critical to the present invention. They can be produced by conventional melt blending of the individual components, by “reactor blending” (“reactor produced”), by combinations of these two processes, or other means which achieves a dispersion of discrete elastomer regions within a substantially continuous polypropylene matrix. By “reactor blending”, it is meant that the polypropylene and rubber components are produced in situ during a single or multiple stage polymerization process.

In one embodiment of producing the impact copolymer, a random ethylene-propylene (“EP”) copolymer is produced in an initial bulk liquid polymerization step conducted in a reactor. In some processes, multiple reactors may be employed for this step. The copolymer is up to 25 wt % ethylene derived units and has a molecular weight above 500,000 Mᵥ (viscosity average molecular weight). The product of the bulk liquid polymerization step is then fed to a gas phase reactor in which a EP rubber is produced. The process is controlled such that the EP rubber formation of the ICP is in the range of up to 30 wt % in one embodiment, and up to 25 wt % in another embodiment, and up to 15 wt % in another embodiment, and from 15 wt % to 22 wt % rubber in yet another embodiment, based on the weight of the ICP.

To this granular reactor product, a stabilizer and a peroxide may be added to allow visbreaking in a following extrusion step conducted in an extruder. The amount of peroxide and the extruder operating conditions are controlled such that the extruded reactor ICP has the desired melt flow rate. The addition of the peroxide is particularly desirable when the ICP is produced using a Ziegler-Natta catalyst system. By maintaining a very high molecular weight in producing the polymerization steps and then visbreaking the copolymer in the extrusion step to yield a lower molecular weight product, a reactor ICP of the desired melt flow rate can be efficiently produced while avoiding potential fouling in the liquid polymerization step. The desired quantity of plastomer (as described more fully below) may be added at the feed point of the extruder.

The ICP useful in the present invention may be made using any appropriate polymerization process. In one embodiment, the process includes the use of a metallocene catalyst system. Such systems are well known in the art, and are able to produce ICPs having certain desirable characteristics. The ICP may have a narrow molecular weight distribution Mw/Mn (“MwD”) of lower than 4.0 in one embodiment, lower than 3.5 in another embodiment, and lower than 3.0 in yet another embodiment, and lower than 2.5 in yet another embodiment. These molecular weight distributions are obtained in the absence of visbreaking using peroxide or other post reactor treatment designed to reduce molecular weight. The ICP has a weight average molecular weight (Mw as determined by GPC) of at least 100,000, at least 200,000 in another embodiment, and a melting point (Mp) of at least 145° C., at least 150° C. in another embodiment, at least 152° C. in yet another embodiment, and at least 155° C. in yet another embodiment.

In one desirable embodiment, the metallocene produced impact copolymer is reactor produced, wherein the “polypropylene component” of the copolymer is produced in one stage, and the “rubber component” is produced in another stage in the presence of the polypropylene component.

Another important feature of metallocene produced ICPs is the amount of amorphous polypropylene they contain, as determined by hexane extractables levels. The ICPs of this invention may be characterized as having low amorphous polypropylene in the polypropylene component (non-rubber component) of the ICP, less than 3% by weight in one embodiment, less than 2% by weight in another embodiment, and less than 1% by weight in yet another embodiment. In yet another embodiment, there is no measurable amorphous polypropylene.

The following racemic metallocenes are most suitable for preparing the ICP compositions in one embodiment of the invention: rac-dimethylsiladiyl(2-iPr,4-phenylindenyl)₂zirconium dichloride; rac-dimethylsiladiyl(2-iPr,4-[1-naphthyl]indenyl)₂zirconium dichloride; rac-dimethylsiladiyl(2-iPr, 4-[3,5-dimethylphenyl]indenyl)₂zirconium dichloride; rac-dimethylsiladiyl(2-iPr, 4-[ortho-methyl-phenyl]indenyl)₂zirconium dichloride; and rac-diphenylsiladiyl(2-methyl-4-[1-naphthyl]indenyl)₂zirconium dichloride. It will be immediately apparent to those skilled in the art that certain modifications to these metallocene species are not likely to result in significantly modified ICP composition though activity or ease of synthesis may be impacted. As such, the present invention contemplates the use of other metallocenes.

Metallocenes are generally used in combination with some form of activator in order to create an active catalyst system. The term “activator” is defined herein to be any compound or component, or combination of compounds or components, capable of enhancing the ability of one or more metallocenes to polymerize olefins. Alkylalumoxanes such as methylalumoxane (MAO) are commonly used as metallocene activators. Generally alkylalumoxanes contain 5 to 40 of the repeating units (“x”):
R(AIRO)ₓAIR₂ for linear species and
(AIRO)ₓ for cyclic species
   where R is a C₁-C₈ alkyl including mixed alkyls. Compounds in which R is methyl are particularly preferred. Alumoxane solutions, particularly methylalumoxane solutions, may be obtained from commercial vendors as 10 solutions having various concentrations. There are a variety of methods for preparing alumoxane, non-limiting examples of which are described in U.S. Pat. Nos. 4,665,208, 4,952,540, 5,091,352, 5,206,199, 5,204,419, 4,874,734, 4,924,018, 4,908,463, 4,968,827, 5,308,815, 5,329,032, 5,248,801, 5,235,081, 5,103,031 and EP-A-0 561 476, EP-B1-0 279 586, EP-A-0 594-218 and WO 94/10180.

Ionizing activators may also be used to activate metallocenes. These activators are neutral or ionic, or are compounds such as tri(n-butyl)ammonium tetrakis(pentafluorophenyl)borate, which ionize the neutral metallocene compound. Such ionizing compounds may contain an active proton, or some other cation associated with, but not coordinated or only loosely coordinated to, the remaining ion of the ionizing compound. Combinations of activators may also be used, for example, alumoxane and ionizing activator combination, see for example, WO 94/07928. Embodiments of the metallocene and activator system useful in making the ICP of the present invention is further disclosed in U.S. Ser. No. 09/535,357 filed on Mar. 24, 2000 (assigned to the assignee of the present invention) and U.S. Ser. No. 09/862,667 filed on May 21, 2001 (assigned to the assignee of the present invention).

In one embodiment of the composition of the invention, an ICP having low amorphous phase is desirable. In this embodiment, the ICP is present from 50 wt % to 85 wt % relative to the composition, wherein the impact copolymer is formed from at least one Component A (“polypropylene component”) and at least one Component B (“rubber component”). The ICP in this embodiment is from 40% to 95% by weight of Component A based on the total weight of the impact copolymer, Component A including propylene homopolymer or copolymer, wherein the copolymer comprises 10% or less by weight ethylene, butene, hexene or octene derived units and the amount of amorphous polypropylene in Component A is less than 2 wt %. Further, the ICP in this embodiment is from 5% to 60% by weight Component B based on the total weight of the impact copolymer, Component B including polypropylene copolymer, wherein the copolymer comprises from 20% to 70% by weight ethylene, butene, hexene and/or octene derived units, and from 80% to 30% by weight propylene derived units.

In another embodiment, Component A is a propylene homopolymer. In yet another embodiment, Component B consists essentially of propylene and from 20% to 70% by weight ethylene. In yet another embodiment, Component B consists essentially of propylene and from 30% to 65% by weight ethylene. And further, Component B has a molecular weight distribution of less than 3.0 in yet another embodiment.

In another embodiment, the polymerization process includes the use of a Ziegler-Natta catalyst system. Examples of suitable catalysts systems and methods of production are found in U.S. Pat. Nos. 6,087,459, 5,948,839, 4,245,062, and 4,087,485. Examples of catalysts systems useful in the formation of the impact copolymer are Ziegler-Natta catalysts systems described in U.S. Pat. Nos. 4,990,479 and 5,159,021. Briefly, the Ziegler-Natta catalyst can be obtained by: (1) suspending a dialkoxy magnesium compound in an aromatic hydrocarbon that is liquid at ambient temperatures; (2) contacting the dialkoxy magnesium-hydrocarbon composition with a titanium halide and with a diester of an aromatic dicarboxylic acid; and (3) contacting the resulting functionalized dialkoxy magnesium-hydrocarbon composition of step (2) with additional titanium halide.

The Ziegler-Natta co-catalyst may be an organoaluminum compound that is halogen free. Suitable halogen free organoaluminum compounds are, in particular, branched unsubstituted alkylaluminum compounds of the formula AIR₃, where R denotes an alkyl radical having 1 to 10 carbon atoms, such as for example, trimethylaluminum, triethylaluminum, triisobutylaluminum and tridiisobutylaluminum. Additional compounds that are suitable for use as a co-catalyst are readily available and amply disclosed in the prior art including U.S. Pat. No. 4,990,477. The same or different Ziegler-Natta catalyst(s) may be used in both the initial and subsequent polymerization steps.

Electron donors are typically used in two ways in the formation of Ziegler-Natta catalysts and catalyst systems. An internal electron donor may be used in the formation reaction of the catalyst as the transition metal halide is reacted with the metal hydride or metal alkyl. Examples of internal electron donors include amines, amides, ethers, esters, aromatic esters, ketones, nitrites, phosphines, stilbenes, arsines, phosphoramides, thioethers, thioesters, aldehydes, alcoholates, and salts of organic acids. In conjunction with an internal donor, an external electron donor is also used in combination with a catalyst. External electron donors may affect the level of stereoregularity and MFR in polymerization reactions. External electron donor materials include organic silicon compounds, for example tetraethoxysilane (“TEOS”), dicyclopentyldimethoxysilane (“DCPMS”) and, and propyltriethoxysilane (“PTES”). Internal and external-type electron donors are described, for example, in U.S. Pat. No. 4,535,068. The use of organic silicon compounds as external electron donors are described, for example, in U.S. Pat. No. 4,218,339,4,395,360, 4,328,122 and 4,473,660.

As described in U.S. Pat. No. 6,111,039, two different donors may be used, for example TEOS in the first liquid bulk reactor and TEOS and DCPMS in the second bulk liquid reactor. In the first bulk liquid reactor, the donor TEOS produces a high MFR polypropylene, and in the second bulk liquid reactor the combination of TEOS and DCPMS produces a low MFR polypropylene which is attributed to the dominance of DCPMS donor in presence of TEOS. This system is often termed “sequential donor” polymerization system.

Regardless of the method of making the ICP, the ICP useful in the present invention has a melt flow rate of from greater than 10 g/10 min in one embodiment, and less than 100 g/10 min in another embodiment, or from 1 to 100 g/10 min in one embodiment, and from 2 g/10 min to 75 g/10 min in another embodiment, and from 3 g/10 min to 50 g/10 min inanother embodiment. In yet another desirable embodiment, the MFR is from 5 g/10 min to 40 g/10 min, and from 15 g/10 min to 40 g/10 min in yet another embodiment, wherein a desirable embodiment may include any combination of any upper MFR limit and any lower MFR limit described herein.

Embodiments of the polypropylene of the invention may contain a 15 nucleating agent, an additive specifically utilized to increase the rate of crystallization of the polymer as it cools from the melt as compared to the same polymer in the absence of such an additive. There are many types of nucleating agents for polypropylene, which would are suitable for inclusion in the polypropylene formulations of this invention. Suitable nucleating agents are disclosed by, for example, H. N. Beck in Heterogeneous Nucleating Agents for Polypropylene Crystallization, 11 J. APPLIED POLY. Sci. 673-685 (1967) and in Heterogeneous Nucleation Studies on Polypropylene, 21 J. POLY. SCI.: POLY. LETTERS 347-351 (1983). Examples of suitable nucleating agents are sodium benzoate, sodium 2,2′-methylenebis(4,6-di-tert-butylphenyl)phosphate, aluminum 2,2′-methylenebis(4,6-di-tert-butylphenyl) phosphate, dibenzylidene sorbitol, di(p-tolylidene)sorbitol, di(p-ethylbenzylidene)sorbitol, bis(3,4-dimethylbenzylidene)sorbitol, and N′,N′-dicyclohexyl-2,6-naphthalenedicarboxamide, and salts of disproportionated rosin esters. The foregoing list is intended to be illustrative of suitable choices of nucleating agents for inclusion in the subject polypropylene formulations, but it is not intended to limit in any way the nucleating agents which may be used.

Other additives may be included in the subject polypropylene formulations as suggested by the intended uses of the materials and the knowledge and experience of the formulator. In one embodiment, included in the polypropylene formulation is a primary antioxidant to deter oxidative degradation of the polymer and an acid scavenger to neutralized acid catalyst residues which may be present in the polymer to a greater or lesser extent. Examples of the former class of additives would be hindered phenolic antioxidants and hindered amine light stabilizers, examples and the application of which are well documented in the art. Examples of the latter category of additives would be metal salts of weak fatty acids such as sodium, calcium, or zinc stearate and weakly basic, naturally occurring minerals such as hydrotalcite or a synthetic equivalent like DHT-4A (Mg_{4.5}AI₂(OH)₁₃CO₃.3.5H₂O, Kiowa Chemical Industry Co., Ltd.). As elsewhere in this specification, these listings of possible additives are meant to be illustrative but not limiting of the choices which may be employ.

In another embodiment, a secondary antioxidant is added to the resultant polypropylene pellets to stabilize the resins to oxidative degradation during high temperature processes to which they might be subjected or during very long storage periods at somewhat elevated temperatures. Representative examples of the former, high temperature stabilizers are organic phosphorous acid esters (phosphites) such as trinonylphenol phosphite and tris(2,4-di-t-butylphenyl)phosphite, and more recently discovered agents such as distearyl, hyroxylamine and 5,7-di-t-butyl-3-(3,4-dimethylphenyl)-3H-benzofuranone. The high temperature stabilizers include distearyl thiodipropionate and other fatty esters of thiodipropionic acid. Other agents of these types, which are too numerous to list here, may likewise be utilized, but the foregoing is a representative, non-limiting list of commonly used examples.

Many other types of additives could be optionally included in the resin formulations of this invention such as lubricants, antistatic agents, slip agents, anti-blocking agents, colorants, metal deactivators, mold release agents, fillers and reinforcements, fluorescent whitening agents, biostabilizers, and others.

In making the interior automotive trim component of the present invention, the ICP may be blended by any appropriate means with the plastomer.

Plastomers

The compositions of the present invention include at least one plastomer in the range of from 15 wt % to 50 wt % of the composition in one embodiment. In another embodiment, the plastomer is present up to 50 wt % of the composition, and up to 47 wt % in another embodiment, and up to 45 wt % in yet another embodiment, and present from at least 15 wt % in one embodiment, and from at least 20 wt % in another embodiment, and from at least 25 wt % in another embodiment, and from at least 30 wt % in another embodiment, and from at least 35 wt % in yet another embodiment, wherein the preferred embodiment can be a combination of any lower wt % limit with any upper wt % limit.

In one embodiment of the invention, the “plastomer” is a copolymer having a density in the range of 0.860 to 0.915 gm/cm³, wherein the plastomer includes ethylene derived units and at least one of C₃ to C₈ α-olefin derived units from 1 wt % to 40 wt % of the plastomer in one embodiment, and from 5 to 35 wt % of the plastomer in another embodiment, and from 5 to 30 wt % of the plastomer in yet another embodiment, wherein a desirable embodiment may be any combination of any upper wt % limit and any lower wt % limit described herein.

In many embodiments it will be desirable to use the lowest density plastomer consistent with maintaining good handling of the plastomer resin. In warm climates, it will often be desirable to use densities above 0.890 gm/cm³, to avoid the need for chilled resin storage, due to cold flow of lower density resins having the desired melt index. The melt index (“MI”) range of the plastomer is in the range of from 0.1 g/10 min to 40 g/10 min in one embodiment, and from 0.5 to 10 g/10 min in another embodiment, and from 2.0 g/10 min to 6 g/10 min in another embodiment, and from 3 g/10 min to 5 g/10 min in yet another embodiment. In some applications it will be desirable to select a plastomer having melt index near that of the ICP used in the composition.

In one embodiment, the plastomers have a density in the range of 0.865 to 0.92 g/cm³; and in the range of 0.87 to 0.91 g/cm³ in another embodiment, and in the range of 0.88 to 0.905 g/cm³ in yet another embodiment and in the range of 0.880 to 0.900 g/cm³ in yet another embodiment. Useful plastomers are copolymers of at least ethylene derived units and at least one of non-cyclic mono-olefins such as propylene, 1-butene, 1-pentene, 1-hexene, 1-octene and 4-methyl-1-pentene, 1-hexene being desirable in one embodiment. However, cyclic mono-olefins and both linear and cyclic dienes can also be used in copolymerization with ethylene to form the plastomer. It is desirable in some applications to use ethylene, α-olefin, diene terpolymers. This is advantageous in that it provides the plastomer with residual unsaturation to allow a functionalization reaction or cross-linking in the rubber phase of the finished product.

In one further embodiment of the invention, the plastomer is a copolymer of ethylene derived units and 1-hexene derived units, wherein the 1-hexene derived units are present from 5 wt % to 35 wt % of the plastomer in one embodiment, from 5 wt % to 30 wt % of the plastomer in another embodiment, and from 10 wt % to 28 wt % in another embodiment, and from 15 wt % to 27 wt % in yet another embodiment, wherein a desirable embodiment can be any combination of any maximum wt % and any minimum wt % value described herein.

Desirable plastomers for use in the present invention are those produced utilizing metallocene catalysts. For example, useful plastomers are those ethylene based copolymer plastomers sold under the trademark EXAC™ (ExxonMobil Chemical Company, Houston, Tex.). These plastomer have a plastic-like molecular weight for better dispersion in polypropylene. They are also free of exterior dusting agents and interior processing aids which could adversely affect the properties of the ICP and the composition as a whole. The invention can also be practiced using ENGAGE™ polymers, another line of metallocene catalyzed plastomers (Dow Chemical Company, Midland, Mich.). Metallocene catalyzed plastomers are characterized by narrow molecular weight distribution, typically in the range of 1.8 to 3.5, low ash content and narrow composition distribution.

Compositions of ICP and Plastomer

Compositions of the ICP and plastomer typically contain from 50 wt % to 85 wt % of the ICP relative to the composition in one embodiment, and from 55 wt % to 75 wt % in another embodiment. Stated another way, the ICP may be present in the composition up to 85 wt % in one embodiment, and up to 80 wt % in another embodiment, and up to 75 wt % in yet another embodiment, and up to 70 wt % in yet another embodiment. The plastomer is present in the composition as defined above.

The manner in which the plastomer and ICP are blended or incorporated to form the composition is not critical, and the invention is not herein limited to the specific morphology of the composition such as, for example, dispersed or continuous, co-continuous with or without sub-inclusions. Mixing techniques common in the art are useful, such as the use of a Brabender or Banbury mixer, or a screw-type extruder, or other suitable blender. For reactor ICPs, the plastomer can be incorporated into the composition by addition of plastomer pellets immediately upstream of the pelletizing extruder. Alternatively, it can be added by the ICP producer or by a compounder in a compounding step after production of the ICP, or by the converter in a blending process prior to fabricating the end product. For compounded blends, the plastomer can be added at the time of melt blending. Alternatively, the plastomer can be pre-blended with the rubber component, with the rubber-plastomer blend later being compounded with the polypropylene in producing compounded ICP/plastomer compositions.

The compositions may also include fillers such as talc, up to 5 wt % of the composition in one embodiment. In one embodiment, fillers are absent from the composition. Further, the composition may advantageously include dyes or pigments, anti-slip agents, antioxidants, and other components common in the automotive parts industry.

Processing oils such as parraffinic oils are substantially absent from the compositions of the invention. By “substantially absent”, it is meant that processing oils are present, if at all, to an extent no greater than 1 wt % of the composition. In another embodiment, processing oils are present, if at all, to an extent no greater than 0.1 wt %. Further, cross-linking agents such as divinyl benzene, organic peroxides or other agents as described in, for example, JP 11181174, and other radical initiators are substantially absent, which means that they are present, if at all, to an extent no greater than 0.01 wt % of the composition. Finally, styrene-based polymers such as styrene-butadiene-styrene block copolymers disclosed in, for example, U.S. Pat. No. 6,060,551, are substantially absent from compositions of the invention, meaning that they are present, if at all, to an extent no greater than 1 wt % of the composition.

In one embodiment of the composition, an article such as an airbag is formed from a composition consisting essentially of an impact copolymer and a plastomer, wherein the plastomer is a copolymer of ethylene derived units and 1-hexene derived units from 10 wt % to 40 wt % by weight of the plastomer in one embodiment, from 15 wt % to 35 wt % by weight of the plastomer in another embodiment, and from 15 wt % to 28 wt % of the plastomer in yet another embodiment. Minor components such as pigments, anti-slip agents, and antioxidants may also be present up to 1 wt % of the composition.

The MFR of the composition may vary from less than 100 g/10 min in a desirable embodiment. Described another way, the MFR of the composition is from 5 g/10 min to 40 g/10 min in one embodiment, and from 6 g/10 min to 30 g/10 min in another embodiment, and from 5 g/10 min to 25 g/10 min in yet another embodiment, and from 10 g/10 min to 15 g/10 min in yet another embodiment, wherein a desirable embodiment of the composition may be defined by any upper MFR limit and any lower MFR limit described herein.

The stiffness, as measured by the flexural modulus is improved relative to the prior art. In one embodiment of the composition of the invention, the secant flexural modulus is greater than 50 kpsi (345 MPa), and greater than 80 kpsi (552 MPa) in another embodiment, and greater than 90 kpsi (621 MPa) in yet another embodiment, and greater than 100 kpsi (690 MPa) in yet another embodiment. Further, the Gardner Impact at −29° C. of the composition is greater than 295 in-lbs (33 J) in one embodiment, greater than 300 in-lbs (34 J) in another embodiment, and greater than 310 in-lbs (35 J) in yet another embodiment. Also, the composition is 100% ductile down to −40° C. as per the instrumented impact (15 mph) values. These improved properties of the composition of the invention are also possessed by components such as airbag covers made from the composition.

The compositions of the invention are useful for articles requiring ductility at low temperatures (−20 to −40° C.) and moderate impact strength, while maintaining a shatter resistance. Such is required for automotive components, especially interior automotive components, such as instrument panel covers, dash board skin, interior fascia, and airbag covers, pillar trim, instrument panel trim, cartridges for head-liners, sill plates, door trim panels, rear quarter panels, seat back covers, as well as exterior features such as air dams, exterior fascia, bumpers and lift gate panels. The compositions of the present invention are particularly useful for interior automotive components such as covers for airbags and pillar trim for side and curtain airbags. The airbag and tether (straps that hold the airbag to the vehicle) is packaged behind the head liner and pillar trim. As the airbag deploys, typically at 150 mph at −30° C., the pillar trim must be able to withstand the impact and/or flex away from the deploying bag. For front passenger seat airbags, the pillar trim is used to deflect the inflating airbag upward in the direction of the passenger. Again, the composition used to make the airbag cover must withstand the impact of the bag.

The compositions of the present invention are particularly well suited for use in unitary interior automotive components suitable for allowance of airbag deployment, while providing aesthetics and structural durability. By “unitary”, it is meant that the component or article of manufacture is capable of being made as one part, or is in fact one part, being continuous even if including perforations, indentations, variations of thickness, or bent, etc. In one embodiment, the unitary component is made in one step such as one injection molding step. This is in contrast to, for example, a steering wheel cover, dashboard or dashboard skin that has an opening molded or cut therein to allow an airbag device to be placed behind the component, then closing the opening with a secondary piece that would allow deployment of the activated airbag (hence, being non-unitary).

For example, a unitary interior automotive component would be a dash board skin or instrument panel cover, trim panel, sill plate, or other items mentioned above that form one unit that may serve in part to cover an airbag and its ensuing components formed from the composition of the invention. Ideally, the unitary interior automotive component would be capable of being produced by standard commercial techniques such as thermoforming or injection molding, such that mass production is feasible and economical. Injection molding of multi-phase polymers, thermoforming, and other suitable processes are described in, for example, POLYPROPYLENE HANDBOOK 154-176, 333-348 (Edward P. Moore, ed., Hanser Publishing 1996), and is common in the art.

Thermoforming is a process of forming at least one pliable plastic sheet into a desired shape. In an embodiment of the present invention, the composition of the invention is thermoformed into a desirable shape, typically the shape of the end use article. An embodiment of the thermoforming sequence is described. First, the desired composition is placed on a shuttle rack to hold it during heating. The shuttle rack indexes into the oven which pre-heats the film or sheet of the composition before forming. Once the film is heated, the shuttle rack indexes back to the thermal forming tool. The film is then vacuumed onto the forming tool to hold it in place and the forming tool is closed. The forming tool can be either “male” or “female” type tools. The tool stays closed to cool the film and the tool is then opened. The shaped laminate is then removed from the tool.

Thermoforming is accomplished by vacuum, positive air pressure, plug-assisted vacuum forming, or combinations and variations of these, once the sheet of material reaches thermoforming temperature of 170° C. to 185° C. A pre-stretched bubble step is used, especially on large parts, to improve material distribution. Plug-assisted forming is generally used for small deep drawn parts. Plug material, design, and timing can be critical to optimization of the process. Plugs made from insulating foam avoid premature quenching of the plastic. The plug shape is usually similar to the mold cavity, but smaller and without part detail. A round plug bottom will usually promote even material distribution and uniform side-wall thickness. For a semicrystalline polymer such as polypropylene, fast plug speeds generally provide the best material distribution in the part.

The formed part is cooled in the mold. Sufficient cooling to maintain a mold temperature of 30° C. to 65° C. is needed. The part should be below 90° C. to 100° C. before ejection. For the best behavior in thermoforming, the lowest melt flow rate polymers are desirable.

Thus, one embodiment of the invention is a unitary interior automotive component including a composition of an impact copolymer and a plastomer, wherein the plastomer is a copolymer of ethylene derived units and at least one of C₃ to C₈ α-olefin derived units from 5 wt % to 35 wt % of the plastomer. The component may be injection molded in one embodiment, and thermoformed in another embodiment. The impact copolymer used may be a metallocene catalyzed, reactor produced copolymer in one embodiment, wherein the polypropylene component of the impact copolymer has an amorphous component of less than 3 wt % in one embodiment, and less than 2 wt % in another embodiment. The composition may have an MFR of from 5 to 40 g/10 min in one embodiment, and from 10 to 15 g/10 min in another embodiment. Further, the impact copolymer may comprises up to 30 wt % of rubber relative to the weight of the impact copolymer.

The composition of the present invention may also be useful for other exterior automotive parts such as bumper fascias, side cladding, bed-liners, wheel flares, fender extension, scuff molding, step pads, bumper end-caps, rocker covers, grilles, valence covers, cowl screen, and energy absorbing bumper beam structures, belly pans, side shields, fender liners. Other applications of the composition of the invention include child car seats, high chairs, baby bottles, cups, lawn tractor parts, ATV fenders, motor cycle fenders, snow mobile bodies, surf board covers, luggage, and tool boxes.

Test Methods

Melt Flow Rate. MFR was measured according to ASTM D1238 test method, at 230° C. and 2.16 kg load, and is expressed as dg/min or g/10 min. The MFR applies to measurements of the ICP and the composition.

Melt Index. MI was measured in accordance with ASTM D 1238 (190° C., 2.1 kg). The MI applies to measurements of the plastomer.

Tensile at Yield and Elongation. Tensile strength at yield was measured according to ASTM D638, with a crosshead speed of 50.8 mm/min, and a gauge length of 50.8 mm, using an Instron machine.

Flexural Modulus. The flexural modulus was obtained according to ASTM D790A, with a crosshead speed of 1.27 mm/min (0.05 in/min), and a support span of 50.8 mm, using an Instron machine.

Gardner Impact. The Gardner impact strength was measured according ASTM D5420, Method G, Procedure GC, at −29° C. and on 90-mm diameter and 3.175-mm thickness disks. The failure mode is classified as shatter, brittle, and or ductile, based on the appearance and condition of the impacted disk. For example, the classification of “shatter” is appropriate when the test disk fractures into multiple pieces (often the number pieces can range from 10 to 15) on impact by the falling weight.

The classification of “brittle” is appropriate when the impacted disk exhibits many radial cracks extending from the area of the impact point. These radial cracks do not propagate all the way to the outer periphery of the disk and portions of the disk defined by the radial cracks do not separate. The classification of “ductile” is appropriate when, after impact, an area of the disk contacted by the weight protrudes from or appears pushed out from the disk surface. The protruding area is generally unsymmetrical and exhibits a crack on one side. Portions of the disk surface defining the extended area appear rough and fibrillar in nature.

The failure modes of brittle-to-ductile, ductile-to-ductile, are combinations of two different types of failure modes exhibited by the disk. The failure mode of brittle-to-ductile, which is between shatter and ductile, is characterized by radial cracks extending from the protruding area. However, portions of the disk defined by the radial cracks do not separate. While the failure modes described above are based on human judgment, rather than a quantitative number from an instrumental evaluation, these failure modes are reproducible and provide both the polymer producer and the parts fabricator with reliable information relative to the suitability of polymers for various applications. An individual trained and experienced in this test procedure can classify different polymeric materials using the Gardner impact test procedure with accuracy.

Notched Izod. The room temperature notched Izod impact strength (“RTNI”) is measured according to ASTM D256 test method. The impact strength equipment is made by Testing Machines Inc.

Heat Deflection Temperature. Heat Deflection Temperature (“HDT”) is a measure of material stiffness as a function of temperature and is expressed in degrees Celsius. End gated rectangular bars of dimension 127 mm×12.7 mm×3.2 mm are used, which are tested under a three point flexural load of 455 kPa, for a 0.25 mm deflection. (ASTM D648-97).

Instrumented Impact Strength. The instrumented impact strength is measured by ASTM D3763-99 using a Dynatup model 8250. A weight of 25 pounds and a speed of 15 miles per hour at the indicated temperatures are used to measure the failure mode and the total energy. The weight is adjusted such that the velocity slowdown is less than 20%.

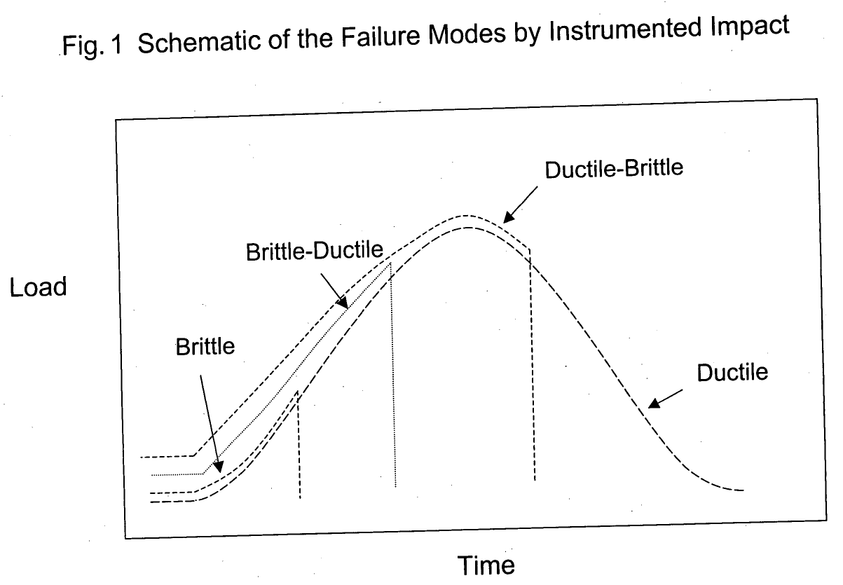

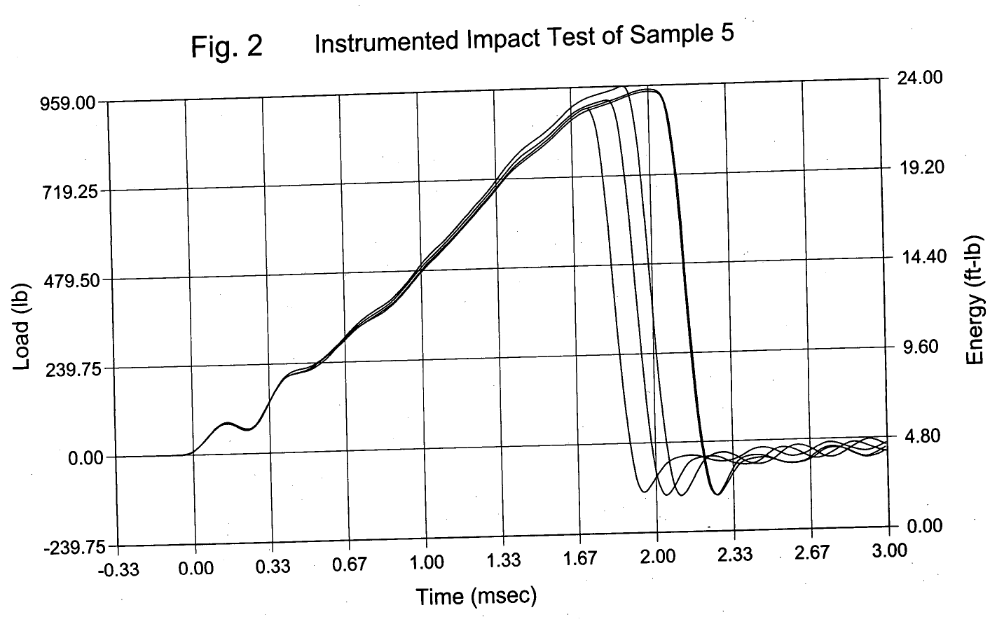

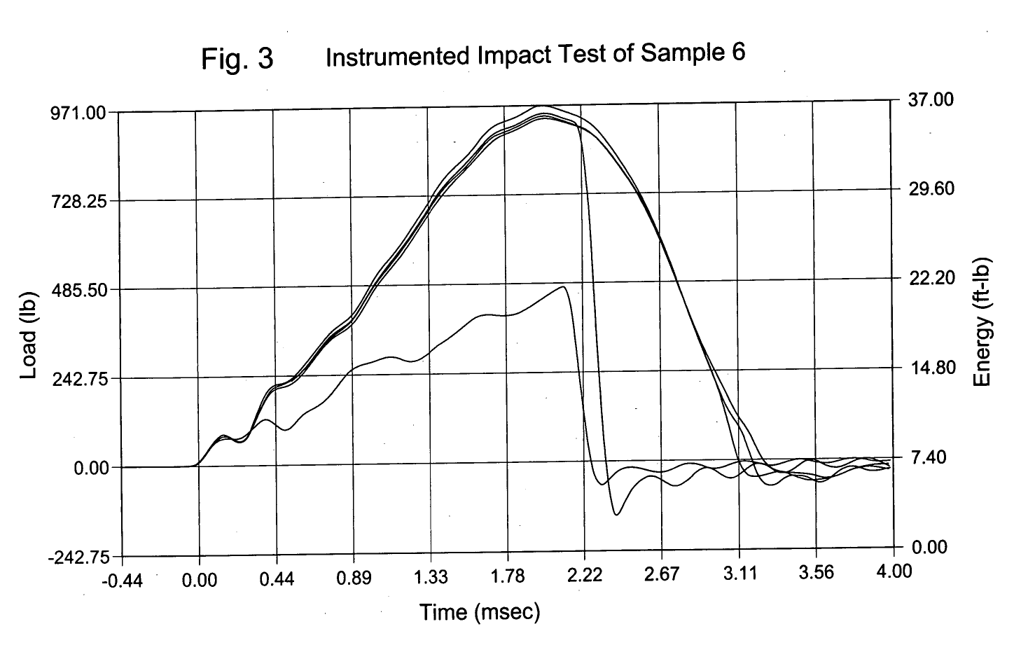

FIG. 1 schematically demonstrates the various classifications shown in Table 4, wherein failure occurs when the load drops at a given time. The failure mode is defined as ductile (D) if the load versus displacement curve is symmetric and/or continuous (bell-shaped or elongated-bell-shaped), there are no radial cracks in the sample, and the tip pierces through the sample. The ductile-brittle (DB) failure mode is defined as the mode where on the load-displacement curve, the load goes through the maximum, and suddenly drops to zero and there are radial cracks in the sample. And, brittle-ductile (BD) failure mode is defined as the condition where in the load-displacement curve, the load falls well before reaching a maximum and the sample breaks into multiple pieces. The desirable failure mode is completely ductile at the specified temperatures. Typically, 5 sample runs were taken of each composition, each sample then evaluated to determine if it is D, DB, or BD. This is represented in Table 4, wherein the number before the “D”, etc. indicates the number of samples that fit that ductility category. FIGS. 2-4 show impact test plots for samples 5, 6, and 11, wherein each trace represents a separate “run” of a fresh sample made from the indicated composition.

A summary of the test methods, and the error of measurement of each, is in Table 1.

### EXAMPLES

The present invention, while not meant to be limiting by, may be better understood by reference to the following example and Tables.

The blending components listed in Table 2 and the formulations listed in Table 3 were dry blended in the pellet form, followed by melt mixing and pelletization using a Reifenhauser single screw extruder having screw diameter of 60 mm and length/diameter (L/D) of 24:1. A 320 mesh screen pack is used in the single screw extruder close to the die for imparting better mixing of the components. The melt temperature was kept in the range of 420-440° F., and the screw speed was 65 rpm. The production rate was 30 pounds/hr.

The pelletized products listed in Table 3, were injection molded into ASTM samples using a 75 ton Van Dom injection molding machine. The sample specimens were tested for different properties listed in Table 1 according to the ASTM protocol.

The impact copolymers listed in Table 2 (PP 7715E4, PP 7414, PP 7032E2 and PP 7033N, commercially available from ExxonMobil Chemical Company, Houston Tex.) are made in series reactors, having the specified levels of ethylene-propylene rubber content and composition. The products contain antioxidants, catalyst neutralizers, and/or nucleating agents. More particularly, additives were combined with the ICPs in Table 2 prior to their incorporation into the plastomer composition. PP7715E4 was extruder blended with 1500 ppm Irganox 1010 (pentaerythritol tetrakis(3-(3,5-di-tert-butyl-4-hydroxyphenyl)propionate, Ciba Specialty Chemicals), 1000 ppm sodium benzoate, 300 ppm DHT4A, and 500 ppm Ultranox 626A (GE Specialty Chemicals). PP7414 was extruder blended with 1500 ppm Irganox 1010, 500 ppm Ultranox 626A, and 800 ppm of calcium stearate. PP7032E2 was extruder blended with 1500 ppm Irganox 1010, 800 ppm of calcium stearate, 250 ppm Irganox 1076, and 2350 ppm of DSTDP (distearyl thiodiphosphate). Finally, PP7033N was extruder blended with 1500 ppm Irganox 1010, 1000 ppm sodium benzoate, 300 ppm DHT4A, 250 ppm Irganox 1076, and 2350 ppm of DSTDP. The indication of the “ppm” is the amount of the additive relative to the entire ICP.

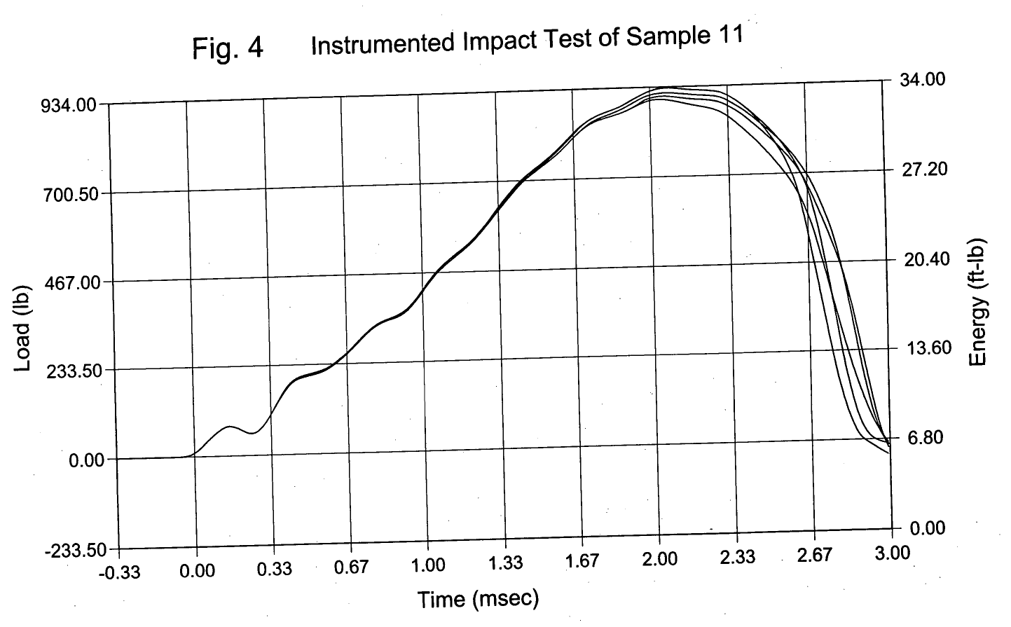

Sample compositions 3-11, and especially 7-11, show an improvement over the comparative samples 1 and 2, wherein the plastomer is present at less than or equal to 15 wt % of the composition. In desirable embodiments, such as in sample compositions 7-11, the instrumented impact is the most desirable. For example, FIG. 4 shows no failures out of 5 runs for sample composition 11. Desirable embodiments of the compositions of the invention have an ICP that has a rubber content of from 18 to 20 wt %, and an MFR of from 15 to 40 g/10 min in one embodiment, and greater than 10 g/10 min in another embodiment. Further, a desirable embodiment such as exemplified in samples 7-11 will have a plastomer content of from greater than 15 wt %. Also, in another desirable embodiment, the ICP is a metallocene produced polymer, wherein the polypropylene phase has an amorphous content of less than 2 wt %. Desirably, the composition is 100% ductile down to −40° C. as tested by instrumented impact as described above and demonstrated in, for example, FIG. 4.

While the present invention has been described and illustrated by reference to particular embodiments, those of ordinary skill in the art will appreciate that the invention lends itself to many different variations not illustrated herein. For these reasons, then, reference should be made solely to the appended claims for purposes of determining the true scope of the present invention.

All priority documents are herein fully incorporated by reference for all jurisdictions in which such incorporation is permitted. Further, all documents cited herein, including testing procedures, are herein fully incorporated by reference for all jurisdictions in which such incorporation is permitted.

TABLE 1
Test Protocols

| | Units (Error in | |
|---|---|---|
| Property | measurement) | Definition or Test |
| MFR or MI | g/10 min | ASTM D1238 |
| Density | g/cm³ | ASTM D-792 |
| Molecular weight distribution | None | GPC |
| Tensile at Yield | Psi (MPa) | ASTM-D638 |
| Elongation at Yield | % | ASTM D-638 |
| Flexural Modulus (1%) | Psi (MPa) (±3%) | ASTM D-790A |
| Gardner Impact at −29° C. | in-lbs. (J) (±5%) | ASTM D-5420G |
| Instrumented Impact Strength | ft-lbs. (J) | ASTM-D-3763 |
| Room Temp. Notched Izod | ft-lb./in. (J/m). | ASTM D-256 |

TABLE 2
Embodiments of ICP and Plastomer useful in compositions

| | EP Rubber | Ethylene derived | | |
|---|---|---|---|---|
| | Content | units in | MFR or MI | Density |
| Product | (wt %) | EP rubber (wt %) | (g/10 min) | (g/cm³) |
| PP 7715E4 | 18.5 | 48 | 35 | 0.900 |
| PP 7414 | 20 | 49 | 20 | 0.900 |
| PP 7032E2 | 17 | 53 | 4 | 0.900 |
| PP 7033N | 17 | 53 | 7.5 | 0.900 |
| EXACT ™ 4150¹ | — | — | 3.5 (MI) | 0.895 |

¹This is a ethylene-hexene copolymer (plastomer) made with a metallocene catalyst system, the hexene derived units present in the plastomer at 22 wt % (ExxonMobil Chemical Company, Houston TX).

TABLE 3
Composition of each sample composition

| Component | | | | | | | | | | | |
|---|---|---|---|---|---|---|---|---|---|---|---|
| (wt %) | C1 | C2 | 3 | 4 | 5 | 6 | 7 | 8 | 9 | 10 | 11 |
| PP 7715E4 | — | — | 61 | — | 78 | 73 | 67 | — | — | — | — |
| PP 7414 | — | — | — | 62 | — | — | — | 83 | 78 | 73 | 67 |
| PP 7032E2 | 90 | — | — | — | — | — | — | — | — | — | — |
| PP 7033N | — | 85 | — | — | — | — | — | — | — | — | — |
| EXACT ™ 4150 | 10 | 15 | 39 | 38 | 22 | 27 | 33 | 17 | 22 | 27 | 33 |

TABLE 4
Measured properties of each sample composition

| Property | C1 | C2 | 3 | 4 | 5 | 6 | 7 | 8 | 9 | 10 | 11 |
|---|---|---|---|---|---|---|---|---|---|---|---|
| MFR (g/10 min) | 4.6 | 7.6 | 21 | 12.6 | 25 | 23 | 23 | 15 | 14.2 | 13.3 | 12.7 |
| Tensile at Yield (psi) | 3220 (22) | 3210 (22) | 2370 (16) | 2290 (16) | 3060 (21) | 2820 (19) | 2670 (18) | 2900 (20) | 2720 | 2640 | 2330 |
| (MPa) | | | | | | | | | (19) | (18) | (16) |
| Elongation at Yield (%) | 9.9 | 11 | 19 | 20 | 9.4 | 13.2 | 17 | 8.6 | 12 | 14 | 19 |
| Elongation at Break (%) | 526 | 530 | 424 | 412 | 680 | 680 | 680 | 750 | 750 | 750 | 750 |
| 1% Secant Flexural | 134 (924) | 147 | 94 (648) | 86 (593) | 138 (952) | 121 (834) | 108 (745) | 127 (876) | 114 | 103 | 87 |
| Modulus (kpsi) (MPa) | | (1018) | | | | | | | (786) | (710) | (600) |
| 1% Tangent Flexural | 140 (966) | 153 | 98 (676) | 89(614) | 144 (983) | 126 (869) | 113(779) | 131 (903) | 118 | 105 | 91(628) |
| Modulus (kpsi) (MPa) | | (1055) | | | | | | | (814) | (724) | |
| Gardner Impact at | 293 (33) | 291 (33) | 309 (35) | 313 (35) | >320 | >320 | >320 | >320 | >320 | >320 | >320 |
| −29° C. (in-lbs) (J) | (D) | (D) | (D) | (D) | (>36) | (>36) | (>36) | (>36) | (>36) | (>36) | (>36) |
| Notched Izod at | No break | No break | No break | No break | No break | No break | No break | No break | No | No | No |
| 23° C. (ft-lbs/in) | | | | | | | | | break | break | break |
| Notched Izod at | 1.2 (64) | 1.61(86) | No break | No break | N/A | N/A | N/A | N/A | N/A | N/A | N/A |
| −20° C. (ft-lbs/in) (J/m) | | | | | | | | | | | |
| HDT at 66 psi (° C.) | 79 | 89 | 76 | 69 | 84 | 80 | 77 | 73.4 | 70.1 | 70.1 | 69.4 |
| Instrumented Impact @ | 35.8 | 35.5 (48) | 32.9 (45) | 32.6 (44) | N/A | N/A | N/A | N/A | N/A | N/A | N/A |
| 15 mph, −18° C. | (49)(5D) | (5D) | (5D) | (5D) | | | | | | | |
| (ft-lbs) (J) | | | | | | | | | | | |
| Instrumented Impact @ | 37.6 (51) | 37.4 (51) | 33.1 (45) | 34.4 (47) | 33.1 (45) | 34.4 | N/A | N/A | N/A | N/A | N/A |
| 15 mph, −30° C. | (5D) | (5D) | (5D) | (5D) | (5D) | (47)(5D) | | | | | |
| (ft-lbs) (J) | | | | | | | | | | | |
| Instrumented Impact @ | 32.8 (44) | 34.3 (47) | 33.2 (45) | 34.5 (47) | 21.4 (29) | 29.2 (40) | 34.6 (47) | 38.2 (52) | 34 (46) | 34 (46) | 35 (47) |
| 15 mph, −40° C. | (2D, 2DB, | (3D, 2DB) | (5D) | (5D) | (3BD, | (3D, 1DB, | (5D) | (5D) | (5D) | (5D) | (5D) |
| (ft-lbs) (J) | 1BD) | | | | 2BD) | 1BD) | | | | | |

N/A means that parameter was not measured.

1. A composition comprising:
(a) from 50 wt % to 85 wt % of at least one impact copolymer relative to the total weight of the composition, the impact copolymer comprising up to 25 wt % of an ethylene-propylene rubber, the rubber having a content of ethylene-derived units of from 40 wt % to 60 wt % relative to the rubber;
(b) from 50 wt % to 15 wt % of at least one plastomer relative to the total weight of the composition, wherein the plastomer is a copolymer of ethylene derived units and at least one of C₃ to C₈ α-olefin derived units from 5 wt % to 30 wt % of the plastomer.

2. The composition of claim 1, the composition having an MFR of from 5 to 40 g/10 min.

3. The composition of claim 2, the composition having an MFR of from 10 to 15 g/10 min.

4. The composition of claim 1, wherein the impact copolymer comprises from 15 wt % to 22 wt % of rubber relative to the impact copolymer.

5. The composition of claim 4, wherein the impact copolymer comprises from 18 wt % to 20 wt % of rubber relative to the impact copolymer.

6. The composition of claim 1, wherein the impact copolymer has an MFR of from 1 g/ min to 100 g/10 min.

7. The composition of claim 6, wherein the impact copolymer has an MFR of from greater than 10 g/10 min.

8. The composition of claim 7, wherein the impact copolymer has an MFR of from 15 to 40 g/10 min.

9. The composition of claim 1, wherein the plastomer has an MI of from 0.5 g/10 min to 10 g/10 min.

10. The composition of claim 9, wherein the plastomer has an MI of from 2 g/10 min to 6 g/10 min.

11. The composition of claim 1, wherein the plastomer is present from 25 wt % to 45 wt % of the composition.

12. The composition of claim 1, wherein the molecular weight distribution of the plastomer is from 1.8 to 3.5.

13. The composition of claim 1, wherein processing oils are present from 0 wt % to 1 wt % of the composition.

14. The composition of claim 1, wherein cross-linking agents are present from 0 wt % to 0.01 wt % of the composition.

15. The composition of claim 1, having a secant flexural modulus greater than 50 kpsi (345 MPa).

16. The composition of claim 15, having a secant flexural modulus greater than 90 kpsi (620 MPa).

17. The composition of claim 1, having a Gardner Impact at −29° C. greater than 295 in-lbs (33 J).

18. The composition of claim 1, wherein the α-olefin derived unit is 1-hexene.

19. The composition of claim 18, wherein the 1-hexene is present from 15 wt % to 27 wt % in the plastomer.

20. The composition of claim 1, wherein the composition is 100% ductile down to −40° C.

21. An automotive component formed from the composition of claim 1.

22. The component of claim 21, wherein the component is selected from interior automotive components, instrument panel covers, dash board skin, interior fascia, airbag covers, pillar trim, instrument panel trim, cartridges for head-liners, sill plates, door trim panels, rear quarter panels, seat back covers, exterior automotive components, air dams, exterior fascia, bumpers and lift gate panels.

23. A composition comprising:
(a) from 50 wt % to 85 wt % of at least one impact copolymer relative to the total weight of the composition, the impact copolymer formed from a Component A and Component B;
(i) wherein from 50% to 95% by weight Component A based on the total weight of the impact copolymer, Component A comprising propylene homopolymer or copolymer, wherein the copolymer comprises 10% or less by weight ethylene, butene, hexene or octene derived units and the amount of amorphous polypropylene in Component A is less than 2 wt %; and
(ii) from up to 50% by weight Component B based on the total weight of the impact copolymer, Component B comprising polypropylene copolymer, wherein the copolymer comprises from 20% to 70% by weight of ethylene, butene, hexene and/or octene derived units, and from 80% to 30% by weight propylene derived units;
(b) from 50 wt % to 15 wt % of at least one plastomer relative to the total weight of the composition, wherein the plastomer is a copolymer of ethylene derived units and at least one of C₃ to C₈ α-olefin derived units from 5 wt % to 30 wt % of the plastomer.

24. The composition of claim 23, wherein Component A is a polypropylene homopolymer.

25. The composition of claim 23, wherein Component A is a copolymer of ethylene and propylene derived units.

26. The composition of claim 23, wherein the impact copolymer comprises from 15 wt % to 22 wt % of Component B relative to the weight of the impact copolymer.

27. The composition of claim 26, wherein the impact copolymer comprises from 18 wt % to 20 wt % of Component B relative to the weight of the impact copolymer.

28. The composition of claim 23, wherein Component B consists essentially of propylene derived units and from 20% to 70% by weight ethylene derived units.

29. The composition of claim 28, wherein Component B consists essentially of propylene derived units and from 30% to 65% by weight ethylene derived units.

30. The composition of claim 23, wherein Component B has a molecular weight distribution of less than 3.0.

31. The composition of claim 23, wherein the composition has an MFR of from 5 to 40 g/10 min.

32. The composition of claim 31, wherein the composition has an MFR of from 10 to 15 g/10 min.

33. The composition of claim 23, wherein the impact copolymer has an MFR of from 1 g/10 min to 100 g/10 min.

34. The composition of claim 33, wherein the impact copolymer has an MFR of from greater than 10 g/10 min.

35. The composition of claim 34, wherein the impact copolymer has an MFR of from 15 to 40 g/10 min.

36. The composition of claim 23, wherein the plastomer has an MI of from 0.5 g/10 min to 10 g/10 min.

37. The composition of claim 36, wherein the plastomer has an MI of from 2 g/10 min to 6 g/10 min.

38. The composition of claim 23, wherein the plastomer is present from 25 wt % to 45 wt % of the composition.

39. The composition of claim 23, wherein the molecular weight distribution of the plastomer is from 1.8 to 3.5.

40. The composition of claim 23, wherein processing oils are present from 0 wt % to 1 wt % of the composition.

41. The composition of claim 23, wherein cross-linking agents are present from 0 wt % to 0.01 wt % of the composition.

42. The composition of claim 23, having a secant flexural modulus of greater than 50 kpsi (345 MPa).

43. The composition of claim 42, having a secant flexural modulus of greater than 90 kpsi (620 MPa).

44. The composition of claim 23, having a Gardner Impact at −29° C. of greater than 295 in-lbs (33 J).

45. The composition of claim 23, wherein the α-olefin derived unit is 1-hexene.

46. The composition of claim 45, wherein the 1-hexene is present from 15 wt % to 27 wt % in the plastomer.

47. The composition of claim 23, wherein the composition is 100% ductile down to −40° C.

48. An automotive component comprising the composition of claim 23.

49. The component of claim 48, wherein the component is selected from interior automotive components, instrument panel covers, dash board skin, interior fascia, airbag covers, pillar trim, instrument panel trim, cartridges for head-liners, sill plates, door trim panels, rear quarter panels, seat back covers, exterior automotive components, air dams, exterior fascia, bumpers and lift gate panels.

50. A unitary interior automotive component comprising a composition of an impact copolymer and a plastomer, wherein the plastomer is a copolymer of ethylene derived units and at least one of C₃ to C₈ α-olefin derived units from 5 wt % to 35 wt % of the plastomer.

51. The component of claim 50, wherein the impact copolymer is a metallocene catalyzed reactor produced copolymer.

52. The component of claim 51, wherein the impact copolymer comprises a polypropylene component having an amorphous component of less than 2 wt %.

53. The component of claim 50, wherein the composition has an MFR of from 5 to 40 g/10 min.

54. The component of claim 53, wherein the composition has an MFR of from 10 to 15 g/10 min.

55. The component of claim 50, wherein the impact copolymer comprises up to 30 wt % of rubber relative to the weight of the impact copolymer.

56. The component of claim 55, wherein the impact copolymer comprises from 15 wt % to 22 wt % of rubber relative to the impact copolymer.

57. The component of claim 56, wherein the impact copolymer comprises from 18 wt % to 20 wt % of rubber relative to the impact copolymer.

58. The component of claim 50, wherein the impact copolymer has an MFR of from 1 g/10 min to 100 g/10 min.

59. The component of claim 58, wherein the impact copolymer has an MFR of from greater than 10 g/10 min.

60. The component of claim 59, wherein the impact copolymer has an MFR of from 15 to 40 g/10 min.

61. The component of claim 50, wherein the plastomer has an MI of from 0.5 g/10 min to 10 g/10 min.

62. The component of claim 61, wherein the plastomer has an MI of from 2 g/10 min to 6 g/10 min.

63. The component of claim 50, wherein the plastomer is present from 10 wt % to 50 wt % of the composition.

64. The component of claim 63, wherein the plastomer is present from 25 wt % to 45 wt % of the composition.

65. The component of claim 50, wherein the molecular weight distribution of the plastomer is from 1.8 to 3.5.

66. The component of claim 50, wherein processing oils are present from 0 wt % to 1 wt % of the composition.

67. The component of claim 50, wherein cross-linking agents are present from 0 wt % to 0.01 wt % of the composition.

68. The component of claim 50, having a secant flexural modulus of greater than 50 kpsi (345 MPa).

69. The component of claim 68, having a secant flexural modulus of greater than 90 kpsi (620 MPa).

70. The component of claim 50, having a Gardner Impact at −29° C. of greater than 295 in-lbs (33 J).

71. The component of claim 50, wherein the α-olefin derived unit is 1-hexene.

72. The component of claim 50, wherein the 1-hexene is present from 15 wt % to 27 wt % in the plastomer.

73. The component of claim 50, wherein the component is 100% ductile down to −40° C.

74. The component of claim 50, wherein the component is injection molded.

75. The component of claim 50, wherein the component is thermoformed.

76. The component according to claims 74 or 75, formed into an article selected from an instrument panel cover, dash board skin, interior fascia, air dams, exterior fascia, bumper, airbag covers pillar trim, instrument panel trim, cartridge for head-liner, sill plate, door trim panel, rear quarter panel, lift gate panel, seat back covers, and the like.
